(19) United States
(12) Patent Application Publication
(10) Pub. No.: US 2015/0111644 A1
(43) Pub. Date: Apr. 23, 2015

(54) PLAYER RANKING SYSTEM BASED ON MULTIPLE QUANTITATIVE AND QUALITATIVE SCORING TYPES

(71) Applicant: Todd Christopher LARSON, Wyoming, MN (US)

(72) Inventor: Todd Christopher LARSON, Wyoming, MN (US)

(21) Appl. No.: 14/520,534

(22) Filed: Oct. 22, 2014

Related U.S. Application Data
(60) Provisional application No. 61/894,351, filed on Oct. 22, 2013.

(51) Int. Cl. A63F 13/798; A63F 13/46

(52) U.S. Cl. CPC A63F 13/798; A63F 13/46
USPC 463/31

(57) ABSTRACT

A ranking system is provided. The ranking system may provide a qualitative method of ranking quantitative evaluation data of players from a plurality of player pools, wherein the plurality of player pools are a subset of the entire group of potential players. The ranking system may provide a method of transforming a plurality of two types—objective and subjective—of evaluation data for a plurality of players into a ranking for each player by standardizing both types on the same on a common scale and applying weights to prioritize specific evaluation and, separately, applying weights to indicate the relative importance between the two types—objective and subjective—of evaluation data, so as to meet the needs of a predetermined team.

### CROSS-REFERENCE TO RELATED APPLICATION

This application claims the benefit of priority of U.S. provisional application No. 61/894,351, filed 22 Oct. 2013, the contents of which are herein incorporated by reference.

### BACKGROUND OF THE INVENTION

The present invention relates to skill assessment and related performance measuring systems and, more particularly, to a system for assessing and ranking potential members of a team.

Organizations have the difficult task of evaluating and ranking potential team members, then making team placement decisions based on that data. This is particularly true when sport organizations evaluate a pool of players when forming their team. A good player evaluation involves multiple sources of data with a diverse set of evaluation criteria to create the most comprehensive and accurate evaluation possible, and so organizations have a difficult time gathering the evaluation data, calculating correct and accurate rankings from the data, making decisions on team placement, and communicating results to the players.

Current systems also do not correctly use quantitative evaluation data along with qualitative data in calculating final player rankings, and so only provide simple player ranking calculations from a single data source and do not help manage the data gathering or reporting processes.

As can be seen, there is a need for a system for evaluating both qualitative and quantitative data and applying multiple objective decision analysis when ranking prospective team members.

### SUMMARY OF THE INVENTION

In one aspect of the present invention, a system for ranking a plurality of players from a plurality of player pools, by transforming quantitative and qualitative evaluation criteria for each player into a final weighted value score, comprising: a computer having a user interface; and a program product comprising machine-readable program code for causing, when executed, the computer to perform the following process steps: receiving at least one evaluation value, wherein evaluation values comprise a quantitative evaluation value associated with a quantitative evaluation criteria and a qualitative evaluation value associated with a qualitative evaluation criteria; transforming each evaluation value to a rescaled evaluation value by applying a statistical function; prompting a user for an evaluation criteria weight for each evaluation value; applying each evaluation criteria weight received to each associated rescaled evaluation value so as to obtain a weighted value score for each evaluation value; and determining the final weighted value score for each player by summing the at least one weighted value score associated with each player.

These and other features, aspects and advantages of the present invention will become better understood with reference to the following drawings, description and claims.

### BRIEF DESCRIPTION OF THE DRAWINGS

FIG. 1 is a block diagram of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a qualitative method of ranking quantitative evaluation data of players from a plurality of player pools, wherein each player pool may be a subset of the entire group of potential players. The ranking system may provide a method of transforming a plurality of two types—objective and subjective—of evaluation data for a plurality of players into a ranking for each player by standardizing both types on a common scale and applying weights to prioritize specific evaluation criteria and, separately, applying weights to indicate the relative importance between the two types—objective and subjective—of evaluation data, so as to meet the needs of a predetermined team.

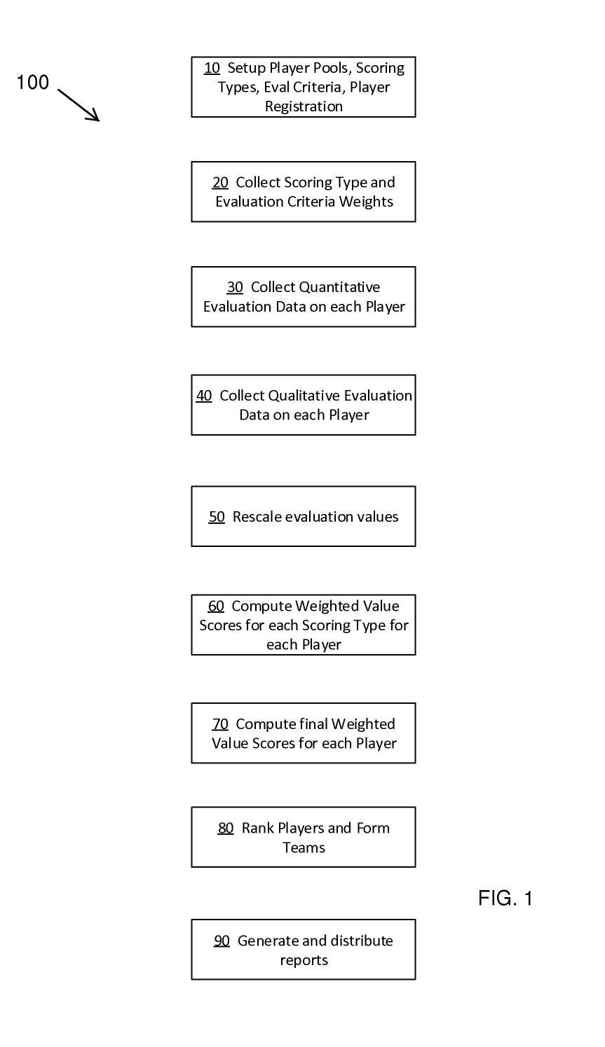

FIG. 1 illustrates a ranking system 100 embodying a method of the present invention for forming a team from a predetermined player pool, wherein each player pool may be a subset of the entire group of potential players. An effective system for player evaluation, generally speaking, involves multiple sources of data with a diverse set of evaluation criteria to create the most comprehensive and accurate evaluation possible.

The ranking system 100 may include at least one computer with a user interface. The computer may include at least one processor electronically connected to a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

Each player pool may be formed from the entire group of potential players that share at least one pool characteristic. The at least one pool characteristic may be comprised of player information. The player information may include a player's name, position played, age, gender, level of experience, and the like. The ranking system 100 may receive the player information from a user through the user interface, from an external source or the like, in step 10. External sources may include, but not be limited to, databases and look-up tables providing player information, exemplary evaluation values and the like. For example, if a user is interested in adding potential players to a team allowing only girls ages 12 through 16, the system 100 may facilitate creation of a relevant player pool of appropriately aged female players through inputting such pool characteristics.

The ranking system 100 may receive a plurality of objective (quantitative) and subjective (qualitative) evaluation data for each player comprising the entire group of potential players. Because the overall skill level desired by a particulate team to be formed can be based on a multitude of factors possessed by each player, the plurality of evaluation data for each player may comprise a plurality of objective (quantitative) and subjective (qualitative) evaluation criteria. All evaluation criteria—objective (quantitative) and subjective (qualitative)—may be grouped into a plurality of scoring types. The plurality of scoring types may include a skill assessment component/type, a statistical component/type, a coaching ranking component/type and a game-play analysis component/type.

The plurality of objective (quantitative) evaluation criteria may be a quantifiably measured value resulting from a non-subjective test, such as found in the skill assessment and statistical component/types, the resulting evaluation values of such quantitative evaluation data being collected by the system 100, in step 30. The skill assessment component/type may include a plurality of objective evaluation criteria measuring the athletic characteristics of each player, for example, the time a player runs the 50-yard dash measuring speed, the height of their vertical jump measuring lower body power, and the like. The statistical component/type may include a plurality of objective evaluation criteria determined from each player's statistics from a predetermined time basis, such as but not limited to the most-recent football game, the most-recent completed year or the like. For example, for a baseball player, this may be the number of homeruns or stolen bases they had last season.

The plurality of subjective (qualitative) evaluation criteria may be evaluated based on a multitude of factors including the personal knowledge and expertise of the evaluator in a given sports area, such as found in the coach rankings and the game-play analysis component/types, the resulting evaluation values of such qualitative evaluation data being collected by the system 100, in step 40. The coaching rankings component/type may include a plurality of subjective evaluation criteria evaluated by an evaluator, such as a coach of the player, an expert or in certain embodiments the user of the system 100. The evaluator ranks the overall talent of the relevant player over the course of the predetermined time basis, wherein the evaluator ranks each player from top to bottom, and wherein the top player is assigned 100 points, and the remaining players get ranked relative to the top player. For example the second best player with similar ability may be assigned a score of 95, and another player of significantly lower ability may be assigned a score of 50, and the like. The game-play analysis component/type may include a plurality of subjective evaluation criteria evaluated by the evaluator during a current game, current scrimmage or the like, based on a set of game-play criteria and a rating system applied thereto, wherein the game-play criteria and the rating scale are the same for all players of any predetermined pool of players. The rating system could be any suitable rating system, such as “1” through “10” where a rating of “1” is least important and a rating of “10” is most important.

The result of each evaluation criteria is an evaluation value, wherein each evaluation value is associated with its relevant scoring type and with each player by the system 100. The ranking system 100 may receive the plurality of evaluation values from the user through the user interface, from the external source, or the like.

In order to allow for accentuating and prioritizing desired evaluation values relative to other evaluation values, the system 100 provides evaluation criteria weights for each evaluation value, in step 20. The system 100 defaults with the evaluation criteria weight of 100 for each evaluation value, though the criteria weight may be adjusted to a value from 0 to 100 by a user of the system 100 for varying priorities based on team needs. The ranking system 100 may receive the evaluation criteria weight from the user through the user interface, from the external source or the like.

In order to compare evaluation values from different types of evaluation data—subjective (qualitative) and objective (quantitative)—it is necessary to standardize the results on a common scale. The ranking system 100 rescales each evaluation value using a statistical function, in step 50. The statistical function, known as “field-scaling”, may be defined as follows:

rescaled evaluation value=(evaluation value−minimum value)/(maximum value−minimum value)

The system 100 may calculate a minimum value and a maximum value from a range of evaluation values for each evaluation criteria. The range of evaluation values may be confined to those associated with the predetermined player pool being considered, and in some embodiments, the range may be drawn from the entire group of potential players. In certain embodiments, the one minimum value and the maximum value may be provided by an external source. The external source may include the user of the system 100 entering the one minimum value and the maximum value through the user interface.

The system 100 may then apply the relevant evaluation criteria weight to each associated rescaled evaluation value, in step 60, resulting in a weighted value score for each evaluation criteria. The system 100 may sum at least one weighted value score for each scoring type for each player to obtain a scoring type weighted sum for each player.

In certain embodiments, the system 100 may provide scoring type weights to the various scoring types so as to indicate the relative importance among scoring types, and specifically between the two types—objective and subjective—of evaluation data, so as to meet the needs of a predetermined team. The system 100 may apply the relevant scoring type weights to each scoring type weighted sum, resulting in a final weighted value for each scoring type. The system 100 may sum the relevant scoring type final weighted values for each player in the player pool to determine a final weighted value score and ranking for each player, in step 70. From the final rankings, the user may form or add to teams based on need, in step 80.

In step 90, the system 100 may generate reports that may organize and summarize the final rankings and the plurality of quantitative data and qualitative values.

It should be understood that the ranking of the players is an iterative process, in that, among other things, the player pools may be redefined, the needs of the team may shift, and updated evaluation data may be received. Meaning, the evaluation criteria are continuously being re-evaluated, updated or changed based on new data. For example, during a baseball season, the user may access the system, possibly through the user interface, on a weekly basis (at least) and uploads new data into the system 100. Such new data can include player statistics from the most-recent baseball game or relevant time basis. Similarly, due to shifting team needs, the various criteria weights may need to be adjusted. Moreover, the player information that defines the relevant player pools can be changed by the user at any time.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for ranking a plurality of players from a plurality of player pools, by transforming quantitative and qualitative evaluation criteria for each player into a final weighted value score, comprising:
a computer having a user interface; and
a program product comprising machine-readable program code for causing, when executed, the computer to perform the following process steps:
receiving at least one evaluation value, wherein evaluation values comprise a quantitative evaluation value associated with a quantitative evaluation criteria and a qualitative evaluation value associated with a qualitative evaluation criteria;
transforming each evaluation value to a rescaled evaluation value by applying a statistical function;
prompting a user for an evaluation criteria weight for each evaluation value;
applying each evaluation criteria weight received to each associated rescaled evaluation value so as to obtain a weighted value score for each evaluation value; and
determining the final weighted value score for each player by summing the at least one weighted value score associated with each player.

2. The system for ranking a plurality of players of claim 1, wherein the statistical function is a field-scaling function.

3. The system for ranking a plurality of players of claim 1, further providing machine-readable program code for causing, when executed, the computer to perform the following process step:
generating a report presenting the final weighted value score for each player.

4. The system for ranking a plurality of players of claim 3, wherein the report is an electronic report.

5. The system for ranking a plurality of players of claim 4, further providing machine-readable program code for causing, when executed, the computer to perform the following process steps:
receiving a plurality of player information for each player;
prompting the user to select at least a portion of the player information to define a predetermined player pool; and
limiting the report of the final weighted value score to players defined by the predetermined player portion.

6. The system for ranking a plurality of players of claim 1, further providing machine-readable program code for causing, when executed, the computer to perform the following process steps:
prompting a user to assign each evaluation value to a plurality of scoring types, wherein the scoring types comprise a skill assessment type, a statistical type, a coach ranking type and a game-play analysis type, and wherein each scoring type has a type criteria weight;
applying each type criteria weight received to each rescaled evaluation value assigned to the relevant scoring type so as to obtain a type weighted value score for each scoring type; and
determining a new final weighted value score for each player by summing all type weighted value scores associated with each player.
